(19) United States
(12) Patent Application Publication
(10) Pub. No.: US 2023/0306998 A1
(43) Pub. Date: Sep. 28, 2023

(54) MAGNETIC DISK DEVICE

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Susumu YOSHIDA, Yokohama Kanagawa (JP)

(21) Appl. No.: 17/941,702

(22) Filed: Sep. 9, 2022

(30) Foreign Application Priority Data
Mar. 23, 2022 (JP) 2022-046430

(51) Int. Cl. G11B 19/04; G11B 5/55; G11B 19/14

(52) U.S. Cl. CPC G11B 19/042; G11B 5/5582; G11B 19/14

(57) ABSTRACT

According to one embodiment, a magnetic disk device includes a magnetic disk, a magnetic head, an actuator, a first stopper, an acceleration sensor, and a controller. The magnetic head is configured to record and reproduce data on and from the magnetic disk. The actuator is configured to rotate about a rotation axis to move the magnetic head. The first stopper is configured to block the actuator in rotation to restrict the actuator from rotating about the rotation axis in a first direction. The acceleration sensor is configured to output an electric signal corresponding to applied acceleration. The controller is configured to, at a time when the actuator abuts against the first stopper, apply a first drive signal to the actuator to measure a first electric signal output from the acceleration sensor, the first drive signal being for driving the actuator in the first direction.

### CROSS-REFERENCE TO RELATED APPLICATIONS

This application is based upon and claims the benefit of priority from Japanese Patent Application No. 2022-046430, filed on Mar. 23, 2022, the entire contents of which are incorporated herein by reference.

### FIELD

Embodiments described herein relate generally to a magnetic disk device.

### BACKGROUND

Performance of magnetic disk devices, such as hard disk drives, may be affected by vibration. In this regard the magnetic disk device includes, for example, an acceleration sensor that detects vibration.

The magnetic disk device also includes an actuator that causes a magnetic head to seek a desired position on a magnetic disk. In some situation, for example, an actuator drive signal may apply noise components to an output of the acceleration sensor due to crosstalk. The magnetic disk device estimates such noise components to remove them from the output of the acceleration sensor, for example.

The magnetic disk device obtains, for example, a function from the output of the acceleration sensor in advance to estimate noise components by the function. The reaction force of the rotating actuator may have an effect on the output of the acceleration sensor based on which the function is generated. In other words, the reaction force of the actuator may have an effect on the noise component estimation.

### BRIEF DESCRIPTION OF THE DRAWINGS

FIG. 1 is an exemplary diagram illustrating an example of a configuration of a magnetic disk device according to a first embodiment;

FIG. 2 is an exemplary plan view schematically illustrating the magnetic disk device according to the first embodiment;

FIG. 3 is an exemplary block diagram illustrating calculation of influence coefficients of the magnetic disk device according to the first embodiment;

FIG. 4 is an exemplary flowchart illustrating an example of a calculation operation for the influence coefficients of the magnetic disk device according to the first embodiment;

FIG. 5 illustrates exemplary graphs of a drive signal according to a command value and detection signals from RV sensors, according to the first embodiment;

FIG. 6 is an exemplary block diagram illustrating correction of the command value of the magnetic disk device according to the first embodiment;

FIG. 7 is an exemplary block diagram illustrating calculation of influence coefficients of a magnetic disk device according to a second embodiment;

FIG. 8 is an exemplary flowchart illustrating an example of a calculation operation for the influence coefficients of the magnetic disk device according to the second embodiment; and

FIG. 9 illustrates exemplary graphs of a negative drive signal according to the command value and the detection signals from the RV sensors, according to the second embodiment.

### DETAILED DESCRIPTION

In general, according to one embodiment, a magnetic disk device includes a magnetic disk, a magnetic head, an actuator, a first stopper, an acceleration sensor, and a controller. The magnetic head is configured to record and reproduce data on and from the magnetic disk. The actuator is configured to rotate about a rotation axis to move the magnetic head with respect to the magnetic disk. The first stopper is configured to block the actuator in rotation to restrict the actuator from rotating about the rotation axis in a first direction. The acceleration sensor is configured to output an electric signal corresponding to applied acceleration. The controller is configured to, at a time when the actuator abuts against the first stopper, apply a first drive signal to the actuator to measure a first electric signal output from the acceleration sensor, the first drive signal being for driving the actuator in the first direction.

### First Embodiment

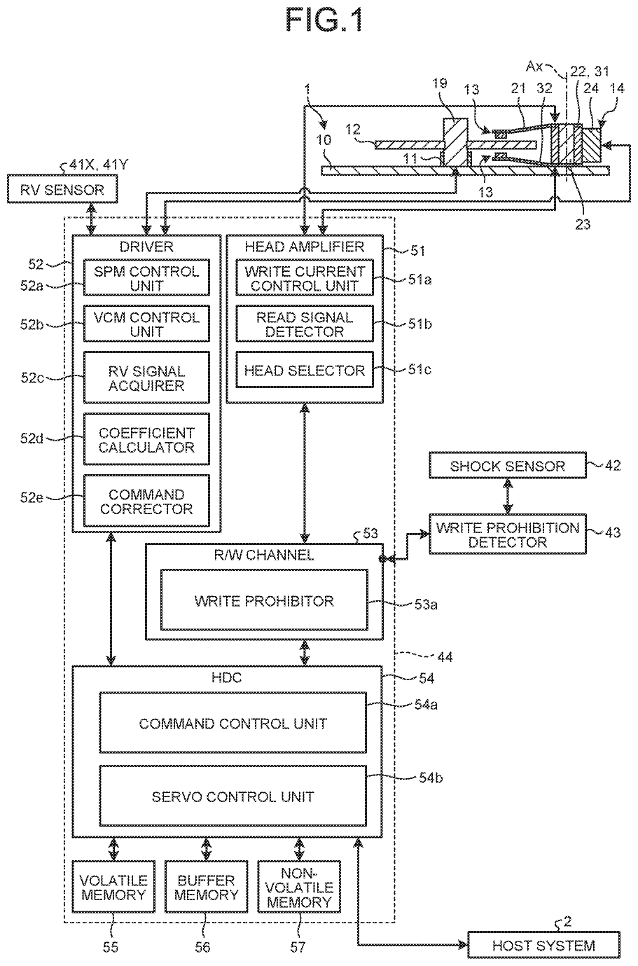

Hereinafter, a first embodiment will be described with reference to FIGS. 1 to 6. Note that, in some cases, a plurality of expressions is used for component elements according to the embodiments and for description thereof, in the present specification. The component elements and the description thereof are presented by way of example only and is not intended to limit the present specification The component elements can be identified by names different from those herein as well. In addition, different expressions from those in the present specification can be given for description of the component elements.

FIG. 1 is an exemplary diagram illustrating an example of a configuration of the magnetic disk device 1 according to the first embodiment. The magnetic disk device 1 is, for example, a hard disk drive (HDD). Note that the magnetic disk device 1 may be another magnetic disk device such as a hybrid HDD.

The magnetic disk device 1 is configured to be connected to a host system 2. The host system 2 is, for example, a processor, a personal computer, or a server. The magnetic disk device 1 and the host system 2 are communicable with each other. For example, the magnetic disk device 1 receives access commands (read command and write command) from the host system 2.

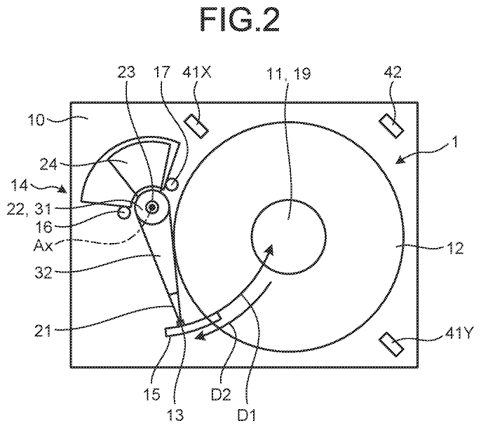

FIG. 2 is an exemplary plan view schematically illustrating the magnetic disk device 1 according to the first embodiment. The magnetic disk device 1 includes a housing 10, a spindle motor (SPM) 11, a plurality of magnetic disks 12, a plurality of magnetic heads 13, and an actuator 14 as illustrated in FIGS. 1 and 2, and a ramp load mechanism 15, a first stopper 16, and a second stopper 17 as illustrated in FIG. 2. Note that FIGS. 1 and 2 illustrate one magnetic disk 12 for the sake of simple explanation.

The housing 10 houses the SPM 11, the plurality of magnetic disks 12, the plurality of magnetic heads 13, the actuator 14, the ramp load mechanism 15, the first stopper 16, and the second stopper 17. The housing 10 is, for example, hermetically sealed.

As illustrated in FIG. 1, the SPM 11 includes a spindle 19. The plurality of magnetic disks 12 is held on the spindle 19 with, for example, a clamp. The SPM 11 is configured to integrally rotate the plurality of magnetic disks 12 around the spindle 19.

Each magnetic disk 12 has recording surfaces on both sides on which data is recordable. The number of the magnetic heads 13 is set so that the magnetic heads 13 can access the recording surfaces of the magnetic disks 12.

Servo information is written into radial servo areas in advance on the recording surfaces of the magnetic disks 12, to define a plurality of radially concentric tracks. Between the servo areas on each recording surface of the magnetic disks 12 a data area on which data is recordable is set. Each track includes one or more sets of the servo areas and the data areas in the circumferential direction.

The plurality of magnetic heads 13 is arranged so as to face the recording surfaces of the corresponding magnetic disks 12. Each magnetic head 13 includes a write head and a read head. The plurality of magnetic heads 13 is configured to record data and reproduce data on and from the recording surfaces of the magnetic disks 12 opposing the magnetic heads 13.

The actuator 14 moves the magnetic heads 13 to the recording surfaces, for example, during seeking and positions the magnetic heads 13 on any of the tracks. The actuator 14 includes a plurality of suspensions 21, a carriage 22, a support shaft 23, and a voice coil 24. The number of suspensions 21 is set corresponding to the number of magnetic heads 13.

The suspensions 21 have an elastically deformable plate shape. The suspensions 21 support the corresponding magnetic heads 13 in the vicinity of the tip end.

The carriage 22 includes an actuator block 31 and a plurality of arms 32. The actuator block 31 is rotatably supported by the support shaft 23, about an axis Ax of the support shaft 23. The axis Ax is an example of the rotation axis.

The plurality of arms 32 protrudes from the actuator block 31 in a direction substantially orthogonal to the axis Ax. The plurality of arms 32 is arranged substantially in parallel. The plurality of suspensions 21 is attached to an end of the corresponding arms 32.

The voice coil 24 is included in the carriage 22. For example, the actuator block 31 is located between the voice coil 24 and the arms 32. The voice coil 24 is placed between a pair of yokes attached to the housing 10. The voice coil 24, the yokes, and magnets placed on the yokes are included in, for example, a voice coil motor (VCM) of the magnetic disk device 1.

Applied with a drive signal (current), the voice coil 24 rotates the carriage 22 and the suspensions 21 attached to the carriage 22 about the axis Ax. The spindle 19 of the SPM 11 and the support shaft 23 of the actuator 14 are substantially parallel and spaced from each other. Because of this, the actuator 14 rotates about the axis Ax to move the magnetic heads 13 attached to the suspensions 21 relative to the magnetic disks 12. The actuator 14 moves the magnetic heads 13 substantially in parallel to the recording surfaces of the magnetic disks 12.

The actuator 14 may further include a micro actuator (MA). The MA is, for example, an actuator element such as a piezoelectric element. The MA is placed in the connection between the suspensions 21 and the carriage 22, and moves each suspension 21 substantially in parallel to the recording surfaces of the corresponding magnetic disk 12.

The ramp load mechanism 15 illustrated in FIG. 2 allows the plurality of magnetic heads 13 to be parked thereon, for example, during unloading and retraction. For example, the ramp load mechanism 15 supports lift tabs provided at the tips of the suspensions 21 to hold the respective magnetic heads 13 supported by the suspensions 21 at retracted positions.

The actuator 14 described above rotates in a first direction D1 or a second direction D2 according to the drive signal applied to the voice coil 24. The first direction D1 is one direction about the axis Ax. The first direction D1 is, for example, a direction from the ramp load mechanism 15 to the spindle 19. The second direction D2 is a direction opposite to the first direction D1. In other words, the second direction D2 is, for example, a direction from the spindle 19 to the ramp load mechanism 15. Note that the first direction D1 and the second direction D2 may be reversed.

The first stopper 16 is fixed to the housing 10. The actuator 14 can rotate in the first direction D1 until it abuts against the first stopper 16 at a predetermined position. For example, the first stopper 16 is spaced from the suspensions 21 and blocks the carriage 22. The first stopper 16 blocks the rotation of the carriage 22 of the actuator 14 to restrict the actuator 14 from further rotating in the first direction D1.

The second stopper 17 is fixed to the housing 10. The actuator 14 can rotate in the second direction D2 until it abuts against the second stopper 17 at a predetermined position. For example, the second stopper 17 is spaced from the suspensions 21 and blocks the rotation of the carriage 22. The second stopper 17 blocks the rotation of the carriage 22 of the actuator 14 to restrict the actuator 14 from further rotating in the second direction D2.

As illustrated in FIG. 1, the magnetic disk device 1 includes RV sensors 41X and 41Y, a shock sensor 42, a write prohibition detector 43, and a control unit 44. The RV sensors 41X and 41Y are examples of the acceleration sensor. The control unit 44 is an example of the controller.

Each of the RV sensors 41X and 41Y and shock sensor 42 detects acceleration or angular acceleration as applied vibration. Note that in the present specification, the angular acceleration is included in the acceleration. The RV sensors 41X and 41Y and the shock sensor 42 each output an electric signal (detection signal) corresponding to the applied vibration.

The RV sensors 41X and 41Y are arranged with spacing from each other. For example, the magnetic disks 12 are arranged between the two RV sensors 41X and 41Y in the direction along the recording surfaces of the magnetic disks 12. The RV sensors 41X and 41Y are fixed to, for example, the housing 10.

For example, substantially circumferential vibration of the magnetic disks 12 can be detected from a difference between a detection value of the RV sensor 41X and a detection value of the RV sensor 41Y. The RV sensors 41X and 41Y output the detection signals to the control unit 44.

The shock sensor 42 is fixed to the housing 10, for example, away from the RV sensors 41X and 41Y. The shock sensor 42 is configured to detect acceleration in three axial directions. Note that the shock sensor 42 is not limited to this example.

The shock sensor 42 outputs the detection signal to the write prohibition detector 43. When the acceleration detected by the shock sensor 42 exceeds a predetermined threshold, the write prohibition detector 43 outputs a write prohibition signal to the control unit 44.

The control unit 44 is communicably connected to the host system 2. In response to a receipt of a command from the host system 2, the control unit 44 performs control according to the command.

The control unit 44 includes a head amplifier 51, a driver 52, a read/write (R/W) channel 53, a hard disk controller (HDC) 54, a volatile memory 55, a buffer memory 56, and a non-volatile memory 57. Note that the control unit 44 is not limited to this example.

The head amplifier 51 is mounted on, for example, a flexible printed circuit (FPC) board inside the housing 10. The driver 52, the R/W channel 53, the HDC 54, the volatile memory 55, the buffer memory 56, and the non-volatile memory 57 are mounted on, for example, a printed circuit board (PCB) outside the housing 10. The FPC and the PCB are electrically connected to each other.

The control unit 44 performs control of the magnetic disk device 1 as a whole by firmware pre-stored in the non-volatile memory 57 or on the magnetic disk 12 in advance. The firmware includes, for example, initial firmware, and control firmware for use in normal operation.

The initial firmware is initially executed at the time of startup and stored, for example, in the non-volatile memory 57. The control firmware for use in the normal operation is recorded on the magnetic disks 12. The control firmware is temporarily read from each magnetic disk 12 to the buffer memory 56 under the control according to the initial firmware and then stored in the volatile memory 55.

The head amplifier 51 selects one of the plurality of magnetic heads 13, amplifies a signal upon writing, and detects a signal upon reading. The head amplifier 51 includes a write current control unit 51a, a read signal detector 51b, and a head selector 51c.

The head selector 51c selects one of the plurality of magnetic heads 13. The control unit 44 controls and positions the magnetic head 13 to the magnetic disk 12, on the basis of the servo information read by the selected magnetic head 13.

The write current control unit 51a controls a write current flowing through the write head of the magnetic head 13, in a state where the magnetic head 13 is positioned. The read signal detector 51b detects the signal read by the read head of the magnetic head 13 positioned. The head amplifier 51 is, for example, an integrated circuit (IC).

The driver 52 drives the SPM 11 and the voice coil 24, and acquires the detection signals from the RV sensors 41X and 41Y. The driver 52 includes an SPM control unit 52a, a VCM control unit 52b, and an RV signal acquirer 52c.

The SPM control unit 52a controls the rotation of the SPM 11. The VCM control unit 52b controls the driving of the voice coil 24. The RV signal acquirer 52c acquires the detection signals from the RV sensors 41X and 41Y. Note that in a case where the actuator 14 further includes the MA, the driver 52 further includes an MA control unit that controls driving of the MA.

The R/W channel 53 passes data between the head amplifier 51 and the HDC 54. Note that the data includes read data, write data, and the servo information. The R/W channel 53 includes a write prohibiter 53a.

When acquiring the write prohibition signal from the write prohibition detector 43, the write prohibiter 53a supplies a write prohibition command to the head amplifier 51. Note that the write prohibiter 53a may supply the write prohibition command to the head amplifier 51 on the basis of a command from the HDC 54.

The head amplifier 51 receiving the write prohibition command from the write prohibiter 53a prevents a write operation to the magnetic disk 12 by the magnetic head 13 from being performed. In other words, the write current control unit 51a prevents the write current from flowing through the write head of the magnetic head 13.

The HDC 54 performs write control and read control on the basis of, for example, the write command and the read command acquired from the host system 2, and passes data between the host system 2 and the R/W channel 53. The HDC 54 includes a command control unit 54a and a servo control unit 54b.

The command control unit 54a performs control of an operation according to the command received from the host system 2. When the HDC 54 receives the command from the host system 2, the command control unit 54a recognizes the received command and selects a control operation according to the recognized command. The command control unit 54a identifies an address or the like included in the command.

In the case of the command being a write command, the command control unit 54a selects the write control according to the write command. The command control unit 54a identifies both of a write address and write data included in the write command.

The servo control unit 54b controls the positions of the magnetic heads 13 according to the control operation selected by the command control unit 54a. The servo control unit 54b controls each magnetic head 13 to seek a target track on each magnetic disk 12 according to the address (e.g., the write address) included in the command. The servo control unit 54b controls the actuator 14 via the driver 52.

The servo control unit 54b controls the actuator 14 to cause the magnetic head 13 to seek and positions the magnetic head 13 on the target track. The target track is designated by the address (e.g., the write address) included in the command.

The servo control unit 54b controls tracking of the magnetic head 13 on the target track of the magnetic disk 12. The servo control unit 54b controls the actuator 14 via the driver 52 to cause the magnetic head 13 to track on the target track.

The driver 52, the R/W channel 53, and the HDC 54 are included in, for example, a system-on-a-chip (SoC). Note that the driver 52, the R/W channel 53, and the HDC 54 may be components different from each other.

The driver 52 of the present embodiment further includes a coefficient calculator 52d and a command corrector 52e. The coefficient calculator 52d calculates an influence coefficient for correcting the detection values of the RV sensors 41X and 41Y. Hereinafter, calculation of the influence coefficient will be described in detail.

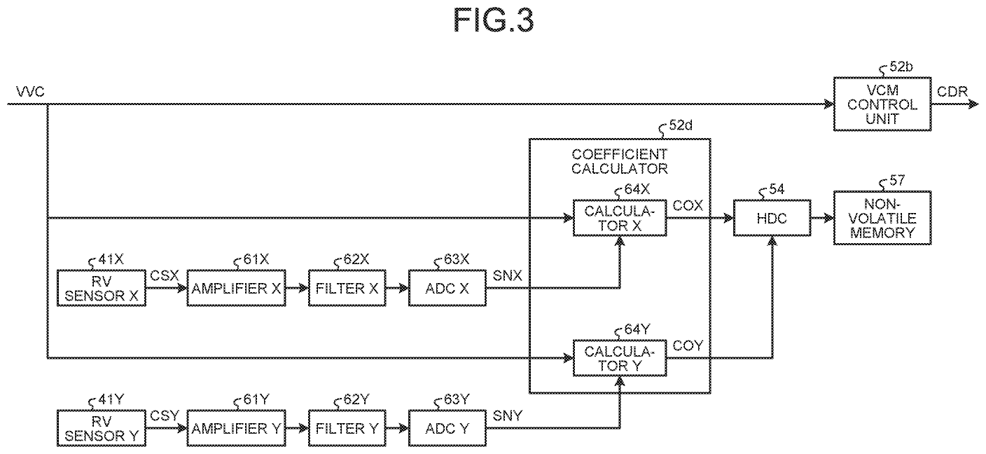

FIG. 3 is an exemplary block diagram illustrating calculation of the influence coefficients COX and COY of the magnetic disk device 1 according to the first embodiment. As illustrated in FIG. 3, the control unit 44 further includes amplifiers 61X and 61Y, filters 62X and 62Y, and analog-digital converters (ADC) 63X and 63Y. Each of the amplifiers 61X and 61Y, the filters 62X and 62Y, and the ADCs 63X and 63Y may be included in the driver 52 or may be a component different from the driver 52.

The amplifiers 61X and 61Y amplify the detection signals CSX and CSY output from the RV sensors 41X and 41Y, respectively. The filters 62X and 62Y remove noise components from the detection signals CSX and CSY amplified by the amplifiers 61X and 61Y. The ADCs 63X and 63Y convert the detection signals CSX and CSY from which the noise components have been removed by the filters 62X and 62Y into digital detection values SNX and SNY. The detection values SNX and SNY are examples of an output value of the electric signal.

The coefficient calculator 52d includes calculators 64X and 64Y. The calculators 64X and 64Y calculate the influence coefficients COX and COY from the detection values SNX and SNY and a command value VVC for the drive signal, for example, output from the servo control unit 54b to the VCM control unit 52b.

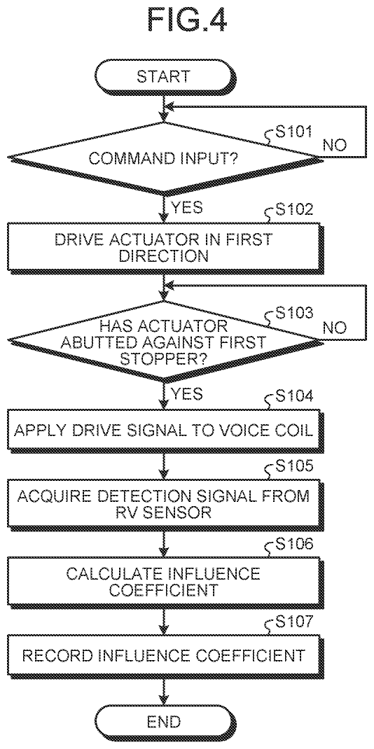

FIG. 4 is an exemplary flowchart illustrating an example of a calculation operation for the influence coefficients COX and COY of the magnetic disk device 1 according to the first embodiment. Hereinafter, the example of the calculation operation for the influence coefficients COX and COY in the present embodiment will be described with reference to FIG. 4.

The influence coefficients COX and COY are calculated, for example, before shipment and after assembly of the magnetic disk device 1. At the time of this calculation, the magnetic disk device 1 is secured and thus prevented from receiving vibration from an external device such as the host system 2. In the following description, it is assumed that the magnetic disk device 1 be subjected to no external vibration.

First, the HDC 54 determines whether to have received a command for calculating the influence coefficients COX and COY from an external device such as the host system 2 (S101). The command is an example of a command signal. Having received no command (S101: No), the HDC 54 repeats S101 until receiving the command.

When the HDC 54 receives a command input (S101: Yes), the command control unit 54a selects a control operation for calculating the influence coefficients COX and COY. The servo control unit 54b controls the driver 52 in the following manner according to the selected control operation.

The VCM control unit 52b of the driver 52 applies a predetermined drive signal (current) to move the actuator 14 in the first direction D1, to the voice coil 24. In other words, the VCM control unit 52b drives the actuator 14 in the first direction D1 (S102).

Next, the servo control unit 54b determines whether the actuator 14 abuts against the first stopper 16 (S103). For example, the servo control unit 54b determines whether the actuator 14 abuts against the first stopper 16, from the position of the magnetic head 13.

The control unit 44 may determine whether the actuator 14 abuts against the first stopper 16 by another method. For example, the VCM control unit 52b may determine whether the actuator 14 abuts against the first stopper 16, from a back electromotive force of the voice coil 24.

When determining that the actuator 14 does not abut against the first stopper 16 (S103: No), the servo control unit 54b or the VCM control unit 52b repeats S103 until the actuator 14 abuts against the first stopper 16. When the actuator 14 abuts against the first stopper 16 (S103: Yes), the servo control unit 54b outputs a predetermined command value VVC to the VCM control unit 52b.

In response to an input of the command value VVC, the VCM control unit 52b applies the drive signal (current) corresponding to the command value VVC to the voice coil 24 (S104). The drive signal corresponding to the command value VVC is an example of the first drive signal.

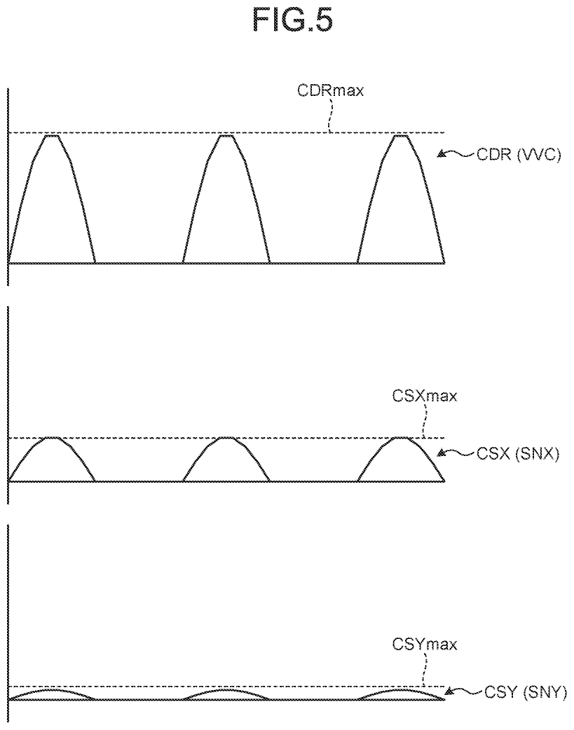

FIG. 5 illustrates exemplary graphs of the drive signal CDR according to the command value VVC and the detection signals CSX and CSY from the RV sensors 41X and 41Y, according to the first embodiment. In FIG. 5, the vertical axes represent current, and the horizontal axes represent time. For example, in the present embodiment, a positive current causes the actuator 14 to drive in the first direction D1. In other words, applied with the positive current, the voice coil 24 rotates the carriage 22 in the first direction D1. A negative current causes the actuator 14 to drive in the second direction D2.

In S104, having received an input of the command value VVC, the VCM control unit 52b applies the drive signal CDR to the voice coil 24. The drive signal CDR is a sine half-wave signal of only the positive current. In other words, the drive signal CDR drives the actuator 14 in the first direction D1.

The first stopper 16 restricts the actuator 14 driven to rotate in the first direction D1 from further rotating in the first direction D1. Because of this, in spite of having received the drive signal CDR, the actuator 14 is substantially maintained in no rotation and in a stationary state. The actuator 14 may slightly rotate.

The drive signal CDR output from the VCM control unit 52b may cause crosstalk between the wiring between the driver 52 and the voice coil 24 and the wiring between the RV sensors 41X and 41Y and the driver 52. In other words, by the VCM control unit 52b's applying the drive signal CDR to the voice coil 24, crosstalk noise may be superimposed on the detection signals CSX and CSY of the RV sensors 41X and 41Y.

The actuator 14 remains stationary, and the magnetic disk device 1 is secured. Thus, the RV sensors 41X and 41Y are subjected to substantially no acceleration. However, due to the crosstalk noise, the detection signals CSX and CSY output from the RV sensors 41X and 41Y have a half-wave waveform corresponding to the drive signal. The detection signals CSX and CSY are examples of the first electric signal.

The RV signal acquirer 52c acquires the detection signals CSX and CSY output from the RV sensors 41X and 41Y (S105). In other words, at the time when the actuator 14 abuts the first stopper 16, the driver 52 applies a positive drive signal CDR to the actuator 14 to drive the actuator 14 in the first direction D1 to the actuator 14 to measure the detection signals CSX and CSY output from the RV sensors 41X and 41Y.

The calculators 64X and 64Y calculate the influence coefficients COX and COY by dividing amplitudes CSXmax and CSYmax of the detection signals CSX and CSY by an amplitude CDRmax of the drive signal CDR (S106). In other words, the influence coefficients COX and COY can be expressed by the following formulas (1) and (2).

COX=CSXmax/CDRmax (Formula 1)

COY=CSYmax/CDRmax (Formula 2)

The calculators 64X and 64Y can calculate the amplitude CDRmax from, for example, the command value VVC. Furthermore, the calculators 64X and 64Y can calculate the amplitudes CSXmax and CSYmax from, for example, the detection values SNX and SNY. Note that the coefficient calculator 52d is not limited to this example.

The HDC 54 acquires the influence coefficients COX and COY from the calculators 64X and 64Y, and records the influence coefficients COX and COY in the non-volatile memory 57 (S107). Note that the HDC 54 may cause the magnetic heads 13 to record the influence coefficients COX and COY on the magnetic disks 12 through the R/W channel 53 and the head amplifier 51. In this manner, the influence coefficients COX and COY are recorded on the magnetic disks 12 or in the non-volatile memory 57.

As described above, upon receipt of the command for calculating the influence coefficients COX and COY, the control unit 44 causes the actuator 14 to abut against the first stopper 16, and applies the drive signal CDR to the actuator 14 to measure the detection signals CSX and CSY. Then, the control unit 44 calculates the influence coefficients COX and COY on the basis of the detection signals CSX and CSY. Note that the control unit 44 may calculate the influence coefficients COX and COY at another timing.

For example, after shipment the HDC 54 acquires the influence coefficients COX and COY from each magnetic disk 12 or the non-volatile memory 57, when applied with power for startup. The HDC 54 outputs the influence coefficients COX and COY to the driver 52.

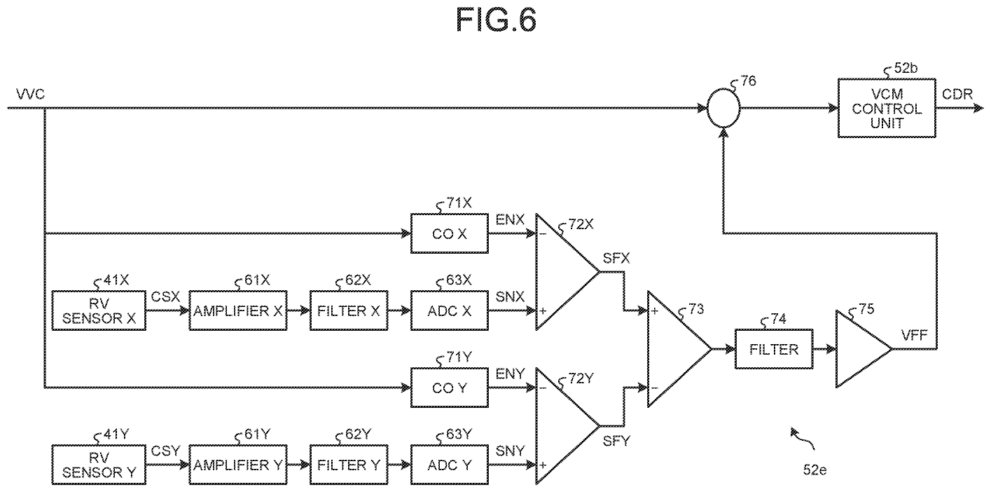

FIG. 6 is an exemplary block diagram illustrating correction of the command value VVC of the magnetic disk device 1 according to the first embodiment. As illustrated in FIG. 6, the command corrector 52e of the driver 52 uses the influence coefficients COX and COY to correct detection values SNX and SNY of the RV sensors 41X and 41Y, and corrects the command value VVC for the drive signal CDR in accordance with corrected detection values SFX and SFY. The corrected detection values SFX and SFY are examples of a corrected output value.

The command corrector 52e includes, for example, coefficient multipliers 71X and 71Y, first subtractors 72X and 72Y, a second subtractor 73, a filter 74, an amplifier 75, and an adder 76. Note that the command corrector 52e is not limited to this example. Each of the coefficient multipliers 71X and 71Y, the first subtractors 72X and 72Y, the second subtractor 73, the filter 74, the amplifier 75, and the adder 76 may be included in the driver 52 or may be a component different from the driver 52.

For example, during seeking, the servo control unit 54b outputs the command value VVC for the drive signal CDR to the driver 52. The coefficient multipliers 71X and 71Y multiply the command value VVC by the influence coefficients COX and COY to calculate noise estimates ENX and ENY. In other words, the noise estimates ENX and ENY can be expressed by the following formulas (3) and (4).

ENX=VVC×COX (Formula 3)

ENY=VVC×COY (Formula 4)

Meanwhile, the ADCs 63X and 63Y convert the detection signals CSX and CSY from which the noise components have been removed by the filters 62X and 62Y into the detection values SNX and SNY being digital signals. The first subtractors 72X and 72Y subtract the noise estimates ENX and ENY from the detection values SNX and SNY, and output the corrected detection values SFX and SFY. In other words, the corrected detection values SFX and SFY can be expressed by the following formulas (5) and (6).

SFX=SNX−ENX (Formula 5)

SFY=SNY−ENY (Formula 6)

The influence coefficients COX and COY can indicate ratios of the noise components per command value VVC. The noise estimates ENX and ENY can indicate amounts of the noise components included in the detection values SNX and SNY. In other words, the command corrector 52e uses the influence coefficients COX and COY to remove the noise components (noise estimates ENX and ENY) from the detection values SNX and SNY.

The second subtractor 73 outputs a difference between the corrected detection values SFX and SFY. The filter 74 removes the noise components from the difference. The amplifier 75 amplifies the difference having the noise components removed by the filter 74, and outputs an RVFF command value VFF.

The adder 76 adds the RVFF command value VFF to the command value VVC and outputs a resultant value to the VCM control unit 52b. The VCM control unit 52b applies the drive signal CDR corresponding to the sum of the command value VVC and the RVFF command value VFF, to the voice coil 24. As described above, the command corrector 52e corrects the command value VVC in accordance with the corrected detection values SFX and SFY.

As described above, the control unit 44 of the present embodiment performs rotational vibration feed-forward (RVFF) control to correct the command value VVC. Furthermore, the control unit 44 corrects the detection values SNX and SNY of the RV sensors 41X and 41Y to be used for the RVFF control, by using the influence coefficients COX and COY. Consequently, the control unit 44 can lessen the influence of the vibration and crosstalk noise on the positioning of the magnetic heads 13, to implement more accurate positioning of the magnetic heads 13.

In the magnetic disk device 1 according to the first embodiment described above, the first stopper 16 works to block the rotating actuator 14 from further rotating about the axis Ax in the first direction D1. At the time when the actuator 14 abuts against the first stopper 16, the control unit 44 applies the positive drive signal CDR to the actuator 14 to measure the detection signals CSX and CSY output from the RV sensors 41X and 41Y. The positive drive signal CDR is for driving the actuator 14 in the first direction D1. In spite of being applied with the drive signal CDR, the actuator 14 is restricted from rotating by the first stopper 16. Because of this, the actuator 14, applied with the positive drive signal CDR, can be prevented from causing the reaction force and the vibration due to the reaction force, which would otherwise occur due to the rotation. Under less or no vibration caused by the reaction force, the detection signals CSX and CSY output from the RV sensors 41X and 41Y can correspond to the crosstalk noise occurring from the positive drive signal CDR. Consequently, the magnetic disk device 1 of the present embodiment can avoid the reaction force due to the rotation of the actuator 14 from affecting the noise measurement, to more accurately measure noise components included in the detection signals CSX and CSY output from the RV sensors 41X and 41Y.

The control unit 44 calculates the influence coefficients COX and COY by dividing the amplitudes of the detection signals CSX and CSY by the amplitude of the positive drive signal CDR. Furthermore, the control unit 44 uses the influence coefficients COX and COY to remove the noise components from the detection signals CSX and CSY output from the RV sensors 41X and 41Y. As an example, the control unit 44 calculates the noise components (i.e., noise estimates ENX and ENY) included in the detection signals CSX and CSY by multiplying the detection values SNX and SNY of the RV sensors 41X and 41Y obtained from the detection signals CSX and CSY by the influence coefficients COX and COY. As such, the magnetic disk device 1 of the present embodiment can more accurately detect its own vibration.

The control unit 44 calculates the noise estimates ENX and ENY by multiplying the command value VVC for the drive signal CDR, which allows the actuator 14 to drive about the axis Ax, by the influence coefficients COX and COY. The control unit 44 subtracts the noise estimates ENX and ENY from the output values (detection values SNX and SNY) of the detection signals CSX and CSY output from the RV sensors 41X and 41Y to calculate corrected detection values SFX and SFY. Furthermore, the control unit 44 corrects the command value VVC according to the corrected detection values SFX and SFY. In other words, the control unit 44 performs feed-forward control to correct the command value VVC in accordance with the detection values SFX and SFY corrected using the influence coefficients COX and COY. Thus, the magnetic disk device 1 of the present embodiment is able to lessen the influence of vibration and noise due to the rotation of the actuator 14, leading to more accurately set each magnetic head 13 at a desired position.

The control unit 44 records the influence coefficients COX and COY on the magnetic disks 12 or in the non-volatile memory 57. The control unit 44 acquires the influence coefficients COX and COY upon being supplied with power. Thereby, the magnetic disk device 1 of the present embodiment can quickly start up without the necessity for measuring the detection signals CSX and CSY.

In response to a receipt of the command for calculating the influence coefficients COX and COY, the control unit 44 causes the actuator 14 to abut against the first stopper 16 and applies the positive drive signal CDR to the actuator 14 to measure the detection signals CSX and CSY. For example, the control unit 44 measures the detection signals CSX and CSY not upon startup but in response to the command during manufacturing. Thereby, the magnetic disk device 1 of the present embodiment can quickly start up without the necessity for measuring the detection signals CSX and CSY.

The actuator 14 includes the suspensions 21, the carriage 22, and the voice coil 24. The suspensions 21 hold the corresponding magnetic heads 13. The carriage 22 to which the suspensions 21 are attached is rotatable about the axis Ax. The voice coil 24 is included in the carriage 22 to rotate the carriage 22 in the first direction D1 when being applied with the positive drive signal CDR. The first stopper 16 is spaced from the suspensions 21, and blocks the carriage 22 in rotation to restrict the actuator 14 from further rotating in the first direction D1. As a result, the magnetic disk device 1 of the present embodiment can prevent the first stopper 16 from deforming the suspensions 21.

### Second Embodiment

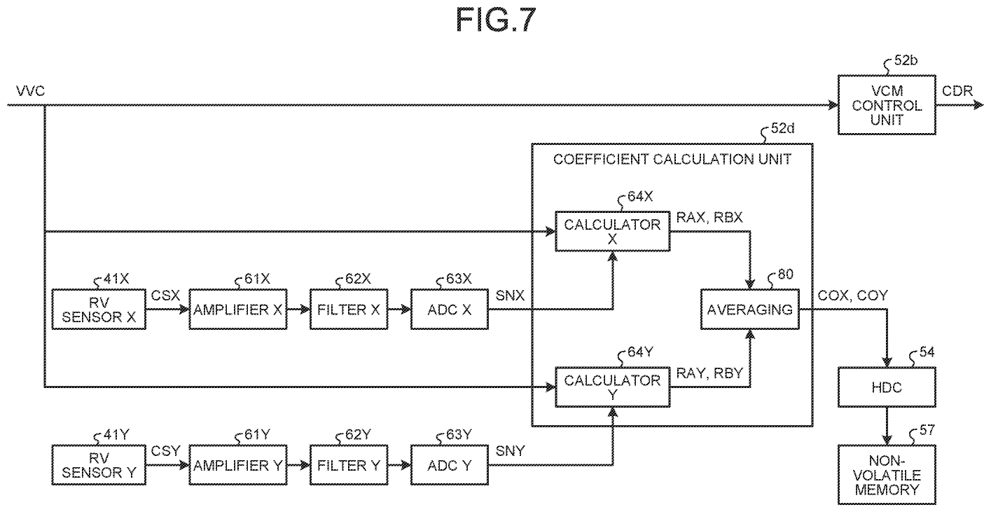

Hereinafter, a second embodiment will be described with reference to FIGS. 7 to 9. Note that in the following description of the embodiment, component elements having functions similar to those of component elements having been described are denoted by the same reference numerals and symbols as those of the component elements having been descried above, and the description thereof may be omitted. In addition, a plurality of component elements denoted by the same reference numerals and symbols does not necessarily have all the functions and properties in common, and may have different functions and properties according to each embodiment.

FIG. 7 is an exemplary block diagram illustrating calculation of the influence coefficients COX and COY of the magnetic disk device 1 according to the second embodiment. As illustrated in FIG. 7, the coefficient calculator 52d of the second embodiment further includes an averaging 80. The averaging 80 averages the values calculated by the calculators 64X and 64Y to calculate the influence coefficients COX and COY.

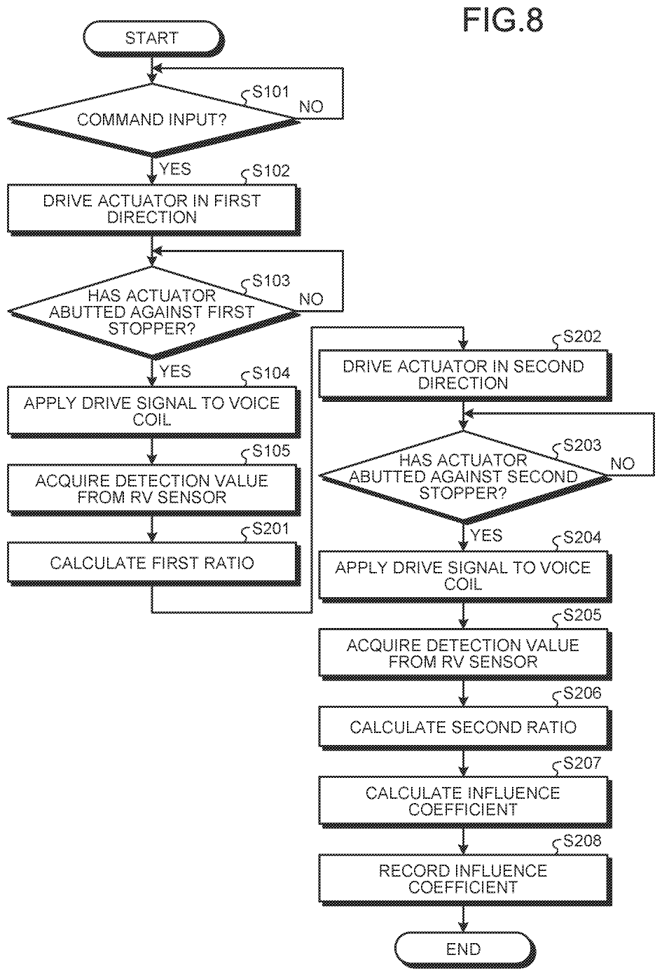

FIG. 8 is an exemplary flowchart illustrating an example of a calculation operation for the influence coefficients COX and COY of the magnetic disk device 1 according to the second embodiment. Hereinafter, an example of the calculation operation for the influence coefficients COX and COY in the present embodiment will be described with reference to FIG. 8.

S101 to S105 are substantially equal to the calculation of the influence coefficients COX and COY in the first embodiment. When the RV signal acquirer 52c acquires the detection signals CSX and CSY in S105, the calculators 64X and 64Y calculate first ratios RAX and RAY by dividing the amplitudes CSXmax and CSYmax of the detection signals CSX and CSY by the amplitude CDRmax of the drive signal CDR (S201). The first ratios RAX and RAY are substantially equal to the influence coefficients COX and COY of the first embodiment.

Next, the VCM control unit 52b of the driver 52 applies a predetermined negative drive signal (current) CDR to move the actuator 14 in the second direction D2, to the voice coil 24. In other words, the VCM control unit 52b drives the actuator 14 in the second direction D2 (S202).

Next, the servo control unit 54b or the VCM control unit 52b determines whether the actuator 14 abuts against the second stopper 17 (S203). When the actuator 14 does not abut against the second stopper 17 (S203: No), the servo control unit 54b or the VCM control unit 52b repeats S203 until the actuator 14 abuts against the second stopper 17. When the actuator 14 abuts against the second stopper 17 (S203: Yes), the servo control unit 54b outputs the command value VVC to the VCM control unit 52b.

In response to input of the command value VVC, the VCM control unit 52b applies the drive signal (current) CDR according to the command value VVC, to the voice coil 24 (S204). The drive signal CDR applied to the voice coil 24 by the VCM control unit 52b in S204 is an example of a second drive signal.

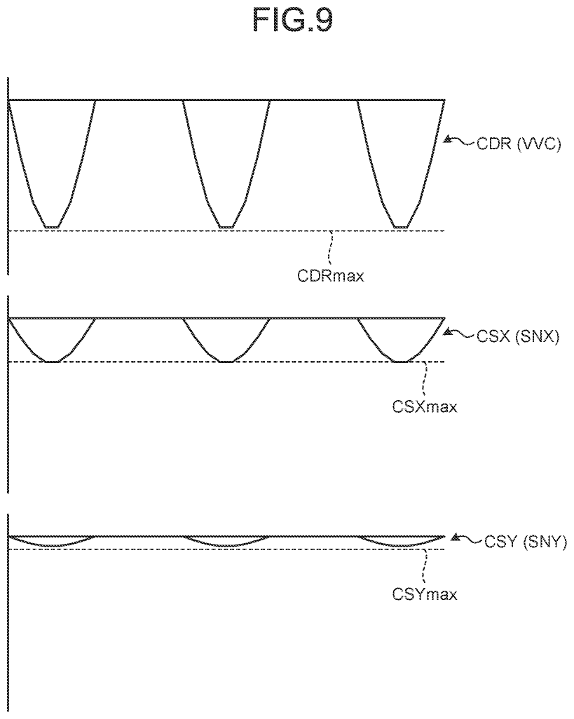

FIG. 9 illustrates exemplary graphs of the negative drive signal CDR according to the command value VVC and the detection signals CSX and CSY from the RV sensors 41X and 41Y, according to the second embodiment. As illustrated in FIG. 9, in S204, the VCM control unit 52b that has received an input of the command value VVC applies, to the voice coil 24, the drive signal CDR that is a SIN wave and that is a half wave in which only the negative current is enabled. In other words, a drive signal DS drives the actuator 14 in the second direction D2.

The second stopper 17 restricts the actuator 14 driven to rotate in the second direction D2 from further rotating in the second direction D2. Having received the drive signal CDR, thus, the actuator 14 is substantially maintained in no rotation and in a stationary state. The actuator 14 may slightly rotate.

Due to the crosstalk noise, the detection signals CSX and CSY output from the RV sensors 41X and 41Y are of half-wave waveform corresponding to the drive signal. The detection signals CSX and CSY are examples of a second electric signal.

The RV signal acquirer 52c acquires the detection signals CSX and CSY output from the RV sensors 41X and 41Y (S205). In other words, at the time when the actuator 14 abuts against the second stopper 17, the driver 52 applies the negative drive signal CDR to drive the actuator 14 in the second direction D2 to the actuator 14, and measures the detection signals CSX and CSY output from the RV sensors 41X and 41Y.

The calculators 64X and 64Y calculate second ratios RBX and RBY by dividing the amplitudes CSXmax and CSYmax of the detection signals CSX and CSY by the amplitude CDRmax of the drive signal CDR (S206). Next, the averaging 80 calculates the influence coefficients COX and COY, as average values of the first ratios RAX and RAY and the second ratios RBX and RBY (S207). In other words, the influence coefficients COX and COY in the second embodiment can be expressed by the following formulas (7) and (8).

COX=(RAX+RBX)/2 (Formula 7)

COY=(RAY+RBY)/2 (Formula 8)

The HDC 54 acquires the influence coefficients COX and COY from the averaging 80, and records the influence coefficients COX and COY in the non-volatile memory 57 (S208). The influence coefficients COX and COY may be recorded on the magnetic disks 12.

As in the first embodiment, the command corrector 52e of the driver 52 uses the influence coefficients COX and COY to remove the noise components (noise estimates ENX and ENY) from the detection values SNX and SNY. In addition, the command corrector 52e corrects the command value VVC on the basis of the corrected detection values SFX and SFY.

In the magnetic disk device 1 of the second embodiment described above, the second stopper 17 blocks the actuator 14 in motion to restrict the actuator 14 from further moving in the second direction D2 opposite to the first direction D1. At the time when the actuator 14 abuts against the second stopper 17, the control unit 44 applies the negative drive signal CDR to the actuator 14 to drive the actuator 14 in the second direction D2, to measure the detection signals CSX and CSY output from the RV sensors 41X and 41Y. The detection signals CSX and CSY correspond to the crosstalk noise occurring from the negative drive signal CDR. The control unit 44 calculates the first ratios RAX and RAY and the second ratios RBX and RBY by dividing the amplitudes CSXmax and CSYmax of the detection signals CSX and CSY by the amplitude CDRmax of the negative drive signal CDR. Furthermore, the control unit 44 removes the noise components from the detection signals CSX and CSY output from the RV sensors 41X and 41Y, using the influence coefficients COX and COY. The influence coefficients COX and COY are the average values of the first ratios RAX and RAY and the second ratios RBX and RBY. For example, the detection values SNX and SNY of the RV sensors 41X and 41Y are obtained from the detection signals CSX and CSY and multiplied by the influence coefficients COX and COY to calculate the noise components (noise estimates ENX and ENY) included in the detection signals CSX and CSY. By this calculation, the magnetic disk device 1 of the present embodiment can more accurately detect its own vibration. In addition, the magnetic disk device 1 can further level the influence that the rotation direction of the actuator 14 has on the noise components.

In any of the above embodiments, the control unit 44 removes the noise components from the detection signals CSX and CSY (detection values SNX and SNY) output from the RV sensors 41X and 41Y by using the influence coefficients COX and COY. However, the control unit 44 is not limited to this example. As an example, the control unit 44 may use the influence coefficients to remove the noise component from the detection signal output from the shock sensor 42.

In the above description, “prevent” is defined as, for example, to prevent generation of an event, action, or influence, or to reduce the degree of the event, action, or influence. Furthermore, in the above description, “restrict” is defined as, for example, to prevent movement or rotation, or to permit movement or rotation within a predetermined range and prevent movement or rotation outside the predetermined range.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk device comprising:
a magnetic disk;
a magnetic head configured to record and reproduce data on and from the magnetic disk;
an actuator configured to rotate about a rotation axis to move the magnetic head with respect to the magnetic disk;
a first stopper configured to block the actuator in rotation to restrict the actuator from rotating about the rotation axis in a first direction;
an acceleration sensor configured to output an electric signal corresponding to applied acceleration; and
a controller configured to:
at a time when the actuator abuts against the first stopper, apply a first drive signal to the actuator to measure a first electric signal output from the acceleration sensor, the first drive signal being for driving the actuator in the first direction.

2. The magnetic disk device according to claim 1, wherein the controller is configured to:
calculate an influence coefficient by dividing an amplitude of the first electric signal by an amplitude of the first drive signal; and
remove a noise component from the electric signal output from the acceleration sensor by using the influence coefficient.

3. The magnetic disk device according to claim 1, further comprising:
a second stopper configured to block the actuator in rotation to restrict the actuator from rotating in a second direction opposite to the first direction,
wherein the controller is configured to:
at a time when the actuator abuts against the second stopper, apply a second drive signal to the actuator to measure a second electric signal output from the acceleration sensor, the second drive signal being for driving the actuator in the second direction;
calculate a first ratio by dividing an amplitude of the first electric signal by an amplitude of the first drive signal;
calculate a second ratio by dividing an amplitude of the second electric signal by an amplitude of the second drive signal; and
remove a noise component from the electric signal output from the acceleration sensor, by using an influence coefficient being an average value of the first ratio and the second ratio.

4. The magnetic disk device according to claim 2, wherein the controller is configured to:
calculate a noise estimate by multiplying a command value for a drive signal by the influence coefficient, the drive signal being for driving the actuator about the rotation axis;
calculate a corrected output value by subtracting the noise estimate from an output value of the electric signal output from the acceleration sensor; and
correct the command value according to the corrected output value.

5. The magnetic disk device according to claim 2, further comprising:
a non-volatile memory, wherein
the controller is configured to:
record the calculated influence coefficient on the magnetic disk or in the non-volatile memory; and
acquire the recorded influence coefficient upon being supplied with power.

6. The magnetic disk device according to claim 5, wherein the controller is configured to:
in response to a receipt of a command signal, cause the actuator to abut against the first stopper and apply the first drive signal to the actuator to measure the first electric signal.

7. The magnetic disk device according to claim 1, wherein the actuator comprises:
a suspension that holds the magnetic head,
a carriage to which the suspension is attached and being rotatable about the rotation axis, and a voice coil included in the carriage, configured to rotate the carriage in the first direction when applied with the first drive signal, and
the first stopper is spaced from the suspension and configured to block the carriage in rotation to restrict the actuator from rotating in the first direction.
